(19) United States
(12) Patent Application Publication
(10) Pub. No.: US 2008/0017034 A1
(43) Pub. Date: Jan. 24, 2008

(54) Process for producing a ceramic filter

(76) Inventors: Thierry Becue, Lyon (FR); Jean Pierre Joulin, Grabels (FR); Bruno Cartoixa, Allegre Les Fumades (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/641,964

(22) Filed: Dec. 20, 2006

(30) Foreign Application Priority Data
Dec. 21, 2005 (FR) 05/13.064

(51) Int. Cl. B28B 1/093

(52) U.S. Cl. 95/285; 264/252; 264/267; 264/631

(57) ABSTRACT

The invention concerns a process for producing a ceramic honeycomb filter from a porous ceramic honeycomb material comprising a plurality of channels extending through it from one end face to the other end face. The process of the invention comprises at least the following steps consisting of a) providing each end face of the honeycomb material with a perforated film the perforations of which are such that the channels traversing the material are alternately open at one or the other of their end faces so that, for each channel open at one end face, the adjacent channels are closed; and b) introducing, by suction through the perforations of the film applied to each end face, a sealing material into the channels to obtain a ceramic filter the channels of which are not sealed at one of the end faces and are sealed at the other end face.

### FIELD OF THE INVENTION

The present invention relates to the field of ceramic materials used to filter liquid or gaseous effluents. More precisely, it relates to a process for producing a ceramic filter from a porous ceramic honeycomb material, said filter possibly being used as a particle filter (PF) for exhaust gas from diesel engines and more specifically as a membrane for filtering liquid effluents, in particular water.

### PRIOR ART

Impure liquid or gaseous effluents have to be filtered before being released; examples are hydrocarbon effluents from refining or petrochemical units or gaseous effluents such as exhaust gases, or before being used in applications needing high purity effluents such as water.

It is known to filter water by tangential separation carried out in ceramic filters, generally termed membranes in this type of application.

With exhaust gases from internal combustion engines, in particular those from diesel engines, which contain soot or particles which pollute the atmosphere and which can cause grave damage to health, different methods have been envisaged to attempt to overcome this problem. In particular, it has been proposed to collect those particles on filters constituted by porous materials placed in the exhaust of the engine. The prior art describes filters consisting of honeycomb type monoliths formed from refractory materials such as cordierite or silicon carbide. Said monoliths include a plurality of channels separated by porous walls, those channels being alternately sealed at one or the other of their ends to constrain the gas stream to diffuse through those walls. In the prior art, it is known to seal the channels alternately at each end face of the monolith by introducing a sealing material into the channels. The sealing material is generally introduced under-pressure (U.S. Pat. No. 4,559,193, U.S. Pat. No. 4,293,357) and/or by vibration (U.S. Pat. No. 4,293,357). The rheological properties of the sealing material must be carefully controlled as the viscosity must be kept high to prevent the seal from flowing while also preventing the injection nozzle(s) from plugging up.

The objective of the present invention is to propose a novel process for producing ceramic honeycomb filters from a porous ceramic honeycomb material, in particular a monolith, the filter obtained using the process of the invention producing very good adhesion of the sealing material with the walls of the monolith and as a result, an excellent hold of the seals formed at one of the ends of each of the channels.

### SUMMARY AND ADVANTAGE OF THE INVENTION

The invention concerns a process for producing a ceramic honeycomb filter from a porous ceramic honeycomb material comprising a plurality of channels extending through it from one end face to the other end face. The process of the invention comprises at least the following steps consisting of a) providing each end face of the honeycomb material with a perforated film the perforations of which are such that the channels traversing the material are alternately open at one or the other of their end faces so that, for each channel open at one end face, the adjacent channels are closed; and b) introducing, by suction through the perforations of the film applied to each end face, a sealing material into the channels to obtain a ceramic filter the channels of which are not sealed at one of the end faces and are sealed at the other end face. The ceramic filter obtained using the process of the invention is advantageously used as a particle filter (PF) for exhaust gases from diesel engines or as a membrane to filter gaseous or liquid effluents, in particular water.

In accordance with the invention, it is advantageous to perforate a film covering each end face of the material using a polarized laser beam after having carried out a digital step for visual recognition of the end faces to determine the locations to be perforated. This digital recognition step allows rapid adaptation to the various channel shapes and can also allow non conformities (voids) present in the network of the porous ceramic material to be processed.

The suction technique as a method for penetrating the sealing material into the channels has the advantage of creating an under-pressure in all of the channels of the porous ceramic material and as a result an under-pressure in the pores of the walls of said material. This under-pressure sucks the suspension containing the sealing material into the pores of the walls located at the interface of the suspension and the walls. Contact between the suspension containing the sealing material and the walls is more intimate and, after drying then calcining, the best penetration of the sealing material, generally a cement, into the pores of the walls located at the seal-wall interface results in better fixing of said seals and thus greater strength compared with those present in a filter obtained using prior art processes, in particular by a process consisting of injecting a suspension or a paste containing the sealing material.

### DESCRIPTION

The present invention provides a process for producing a ceramic honeycomb filter from a porous ceramic honeycomb material comprising a plurality of channels extending through it from one end face to the other end face, said process comprising at least the following steps consisting of:

a) providing each end face of the honeycomb material with a perforated film the perforations of which are such that the channels traversing the material are alternately open at one or the other of their end faces so that, for each channel open at one end face, the adjacent channels are closed; and

b) introducing, by suction through the perforations of the film applied to each end face, a sealing material into the channels to obtain a ceramic filter the channels of which are not sealed at one of the end faces and are sealed at the other end face.

In an advantageous implementation of the process of the invention, step a) of said process is preceded by a step consisting of applying to each of the end faces of the ceramic material a non-perforated film followed by a step consisting of perforating said non-perforated film at the desired locations. Perforation is thus carried out when the film is already applied to each of the end faces of the ceramic material. It is also possible to apply a pre-perforated film directly to each of the end faces.

In accordance with the invention, the film perforations are made at locations corresponding to the given channels opening at the end faces of the porous ceramic honeycomb material. The film perforations are such that for each open channel at one end face, i.e. not covered with film, the adjacent channels are closed, i.e. covered by the film. In this manner, the perforated or pre-perforated films placed on the end faces of the ceramic material form a mask on each of said faces: only the open channels will be obturated by the sealing material during step b) of the process of the invention. It is also essential that the open channels at one of the end faces are closed at the other end face and vice versa so that the channels traversing the ceramic material are alternately open at one or other of the end faces. It transpires that after carrying out step b) of the process of the invention, i.e. introducing a sealing material into the open channels at each end face of the ceramic material, the channels which are sealed at one end face are not sealed at the other face, the channels thus being alternately sealed on one or the other of the end faces of the ceramic filter. In this manner, after removing the film from each of the end faces, for example by mechanical removal or by calcining at a temperature in the range 250° C. to 400° C., a ceramic filter is obtained. Said ceramic filter can be used as a particle filter within which a gas stream containing soot and/or polluting particles moves. Said ceramic filter is also useful as a membrane within which a liquid or gaseous stream is moved, preferably liquid and more preferably aqueous, containing organic or inorganic material in suspension such as microorganisms (larvae, bacteria, spores, etc), organic macromolecules, colloids or inorganic dust. Whatever the envisaged application, the liquid or gaseous stream is introduced into the inlet to the non sealed channels of one end face of the ceramic filter, diffuses through the porous walls separating the channels and leaves via the unsealed channels of the other end face.

A film applied mechanically to the end faces of the ceramic material must be sufficiently strong not to be ruptured when the sealing material is introduced by suction through the perforations of said film. The film must also resist the chemical nature of the suspension containing the sealing material; in particular, it must not degrade in the presence of water or as a function of the acido-basic conditions of the suspension. Advantageously, it is a film formed from a polymeric material, for example a polyester. Highly advantageously, an adhesive polypropylene film with a thickness of 50 μm or a stretchable polyethylene film is used on the peripheral surface of the ceramic material to seal it and provide a better vacuum in the channels and the pores of the walls of these channels. In a particular implementation of the invention, the films are produced from a heat-shrinkable material so that each of the films, once applied to each of the end faces, can be overlapped and sealed during a shrinking step carried out at a temperature of close to 50° C., for example continuously in a continuous oven. The porous ceramic honeycomb material is then placed in a heat-shrinkable sheath. It may advantageously be a heat-shrinkable sheath of polyethylene with a thickness of 120 μm.

The films applied to each end may be perforated by different means. As an example, they may be perforated using at least one needle. The needle is preferably heated to a temperature in the range 50 to 250° C., more preferably in the range 75° C. to 125° C., before perforating the film in a manner such that, for each channel open at one end, the adjacent channels are closed. When the film is perforated, the needles are retracted from the film. The shape of the needle and/or arrangement of needles are advantageously adapted to that of the channels. To carry out the perforation step, a perforation system may be used which includes as many needles as there are perforations to be made in the film. Highly advantageously, the film covering each of the end faces is perforated by irradiating said film at the desired locations by energetic radiation, advantageously a laser type beam and highly advantageously a CO₂ laser. Clearly, said energetic radiation is compatible with the chemical nature of the film to be perforated. A CO₂ laser is particularly compatible with a polyester film. Prior to the film irradiation step, it is preferable, using a digital method involving an algorithm, to carry out a step for visual recognition of the end face to be perforated using a digital camera, in particular a charge transfer device (CCD, coupled charged device camera) to view the channels to be sealed. Advantageously, an apparatus sold by Renaud Lasers is used; its characteristics are given in French patent FR-A-2 842 131 or US-A-2005/205539, the contents of those applications being hereby incorporated by reference. It is also possible to carry out the perforation step chemically, in particular by depositing micro-droplets at the regions on the film to be perforated, said micro droplets being formed by a solution or a solvent such as ethyl ether, concentrated nitric acid or concentrated sulphuric acid.

The porous ceramic honeycomb material is preferably a monolith. It is crisscrossed by a plurality of channels, which are mutually parallel, extending from one end face to the other end face, the channels possibly having a square, rectangular, triangular, hexagonal or polygonal shape. Any ceramic material may be suitable, in particular cordierite, mullite, silicon carbide SiC, silicon nitride, aluminum titanate, zirconium phosphate or alpha alumina. It may be a pure ceramic material, i.e. formed from a single ceramic composition or from a composite ceramic material, i.e. formed from several different ceramic compositions.

When used as a particle filter, said porous ceramic honeycomb material generally has a porosity of 35% to 65% by volume, preferably 40% to 60% by volume. Preferably, the pore distribution is essentially mono distributed and may, for example, be centred between 5 and 60 micrometres, preferably between 10 and 40 micrometres and more preferably between 15 and 35 micrometres.

The channels traversing said material constituting the filter are alternately open or sealed at each end face so that for each channel which is open at one end, the adjacent channels are sealed, the liquid or gas stream penetrating into the filter obtained using the process of the invention thus being constrained to diffuse through the porous walls separating the channels. As an example, in the case of a particle filter (PF) preferably having square cross section channels, the end faces of the monolith having the appearance of a checkerboard. The PF may have about 50 to 500 channels per square inch (i.e. about 7.7 to 77.5 channels per cm²), more particularly about 150 to 300 per square inch (i.e. about 23.5 to 46.5 channels per cm²), which approximately corresponds to a channel cross section of about 0.5 to 9 mm², more particularly 1.4 to 4 mm² with a thickness of the walls separating the channels of about 0.2 to 1.5 mm, more particularly 0.3 to 0.6 mm.

In accordance with the invention, the sealing material introduced into the channels is a thixotropic material. It is preferably a cement the formulation of which is adapted to the conditions of use of the ceramic filter, to the formulation and to the mechanical properties of the porous ceramic honeycomb material. The cement with thixotropic behaviour has a high instantaneous viscosity when it is placed under stress, which stabilizes at between 10 and 40 Pa·s depending on the stress, this phenomenon being reversible. Preferably, the cement is mixed with other elements, for example additives, plasticizers, surfactants, binders or stabilizers. Cement preparation is well known to the skilled person. In general, the mineral mass used as the substance for the cement, for example silicon carbide, is dispersed and the organic adjuvants are hydrolyzed when they are present in the final formulations. The seals formed at the ends of the channels of each of the two end faces of the porous ceramic honeycomb material are preferably constituted by 85% to 95% by weight of a chamotte, preferably formed by at least 30% of particles with a mean dimension equal to a third of the mean pore size of the porous ceramic honeycomb material and having a formulation which is identical to the porous ceramic honeycomb material and 5% to 15% by weight of ceramic binders. Preferably, the sealing material has a thermal expansion coefficient which is lower than that of the porous ceramic honeycomb material. The thermal expansion coefficient of the porous ceramic honeycomb material is advantageously 5% higher than that of the sealing material.

In step b) of the process of the invention, the sealing material, preferably a cement, is introduced by suction through the perforations in the film of one first end face then a second end face opposite to said first end face. Initially, 2 to 30 mm, preferably 3 to 20 mm of a first end of the ceramic material is immersed in a suspension containing the sealing material to seal the open channels of one first end face provided with a perforated film as in step a) of the process of the invention, while the other end of the ceramic material opposite to said first end is connected to a means which can create an under-pressure in the ceramic material and thus suck the sealing material through the perforations of the film of said first end face. The under-pressure in the ceramic material is advantageously created by means of a vacuum pump. In general, a primary vacuum of up to 10⁻³ bars is sufficient. It is also possible to use a higher vacuum, for example a high vacuum of up to 10⁻⁶ bars. The suction sealing technique has the advantage of being very simple to carry out and of being cheap, as well as readily being adapted to any channel shape. When the channels of the first end face are correctly sealed, the vacuum is broken and the end of the material connected to a means for producing an under-pressure is released from that means. Subsequently, by calcining or mechanically, the film on said first end face is removed. Depending on the Theological properties of the suspension containing the sealing material, intermediate drying may be carried out at a temperature in the range 20° C. to 120° C. of the seals formed in the channels at the ends of the first front face before introducing sealing material into the channels at the ends of the second face of the porous ceramic honeycomb material, preferably a monolith, by suction. The sealing operation is then repeated at the second end face of the material in a manner analogous to that employed for the first end face. The quantity of suspension containing the sealing material and in which each end face is immersed is adjusted at the beginning so that the seals, constituted by sealing material introduced in alternating manner into the channels of each end face, are essentially located on the terminal portion of each of the channels. Preferably, the length of each seal is in the range 3 to 10 mm and generally represents between 0.1% and 13%, preferably between 0.2% and 5% of the length of the filter. The seal length advantageously represents 1 to 5 times, highly advantageously 2 to 3 times the inscribed diameter of the seal.

Advantageously, the superficial portion of the sealing material overflowing from each of the end faces is removed. In particular, the seals may be finished using a slip stripper constituted by a rotating foam strip the lower part of which dips in water.

In step b) of the process of the invention, initially, the sealing material is preferably introduced into the channels at the ends of a first end face, the seals formed are optionally dried in said channels, preferably at a temperature in the range 20° C. to 120° C., then the sealing material is introduced into the channels at the ends of said second end face, the channels which are not sealed on the first end face being so on the second end face. Introduction of the sealing material into the channels at the end of said second end face is advantageously followed by a step for drying the seals at a temperature which is preferably in the range 70° C. to 120° C.

After carrying out step b) of the process of the invention, it is advantageous to carry out a step c) consisting of a firing step at a temperature in the range 1000° C. to 1650° C. to sinter the seals. This firing step is carried out in a continuous furnace, for example.

After carrying out step b) and step c) of the process of the invention, it is advantageous to introduce a catalytically active phase into the ceramic filter, in particular when it is used as a particle filter.

In accordance with the process of the invention, the porous ceramic honeycomb material in the form of a monolith used to produce the ceramic filter has been extruded, said extrudates having been fired then assembled if appropriate. In particular, the porous ceramic honeycomb material in the monolithic form may be produced by any appropriate mode comprising a step for mixing the constituents, resulting in a homogeneous product in the form of a bound paste, a step for extruding said product through a suitable die to form said material into the shape of a honeycomb type monolith, a step for drying then a step for firing the monolith obtained at a temperature which is generally in the range 1000° C. to 1650° C.

In the extrusion step, the paste is, vacuum extruded, for example, generally under 15 to 20 mm of mercury, in a screw extruder (single or twin screw) or a piston extruder, to obtain unfired ceramic blocks in the form of a honeycomb monolith. Said ceramic blocks are then dried in a controlled moisture atmosphere for a time sufficient to bring the non chemically bound water content (free water) to less than 1% by weight, drying lasting about twenty hours, and then it is fired. The monolith structures may consist of elementary monoliths which are assembled by ceramic bonding using any method which is known to the skilled person to constitute, for example, the particle filter with the desired geometry which can be installed in the exhaust line of a diesel engine or filtration membrane. When several elementary monolithic structures are to be assembled, assembly is carried out after firing the extrudates. Highly advantageously, it may also directly use a monoblock elementary monolith with a shape adapted to its application, for example with a circular or rectangular cross section.

The ceramic filter obtained using the process of the invention is characterized by scanning electron microscopy which can demonstrate the intimate contact between the sealing material, i.e. the seals, and the porous walls separating the channels as well as part of the sealing material penetrating into said walls. The contact surface area between the sealing material or seals and the porous walls separating the channels is at least 80%, preferably in the range 90% to 100%, i.e. at least 80%, preferably 90% to 100% of the periphery of the seals which matches the channel shape is in intimate contact with the channel walls.

The following examples are given by way of illustration of the invention and do not limit its scope.

### EXAMPLE 1

### Preparation of Ceramic Filter Based on a Honeycomb Monolith Formed from Silicon Carbide

A silicon carbide honeycomb monolith was used with square section channels separated from each other by a porous wall 0.4 mm thick. Said monolith had 200 channels per square inch (i.e. 31 channels per cm²). This monolith was in the form of extrudates which were dried at 110° C. then fired at a temperature of 1450° C. in air. An initial step was carried out to digitize the end faces, consisting of placing the ceramic monolith under a digital camera. The captured image was processed digitally to determine the centres of the channels to be sealed. A non-perforated adhesive polypropylene film was then applied to each of the end faces of the monolith. A first end face covered with said film was perforated by irradiating with a CO₂ laser with a wavelength of 10640 nm with a pulse frequency of 100 Hz to 10 kHz and an adjustable power up to a maximum of 100 W at locations determined during the face digitization step. The apparatus used to carry out both the step for visual digital recognition of the end faces and the laser perforation step is sold by Renaud Laser and has been described in patent application FR-A-2 842 131 or US-A-2005/205539 the contents of which are hereby incorporated by reference. When said film covering said first end face was correctly perforated, the monolith was turned using an articulated arm to perforate the film covering the second end face of the ceramic monolith using the procedure used to perforate the film covering the first face.

A cement used as the sealing material comprised 89.5% by weight of silicon carbide, wherein 30% by weight of the composition was constituted by a grain with a mean diameter in the range 6 to 8 micrometres, 10% by weight of a mixture of 50 parts alumina, 5 parts zirconia, 45 parts of silica, 0.2% by weight of a cellulose plasticizing agent (carboxymethylcellulose) and 0.3% by weight of a thixotropic agent (xanthan). A suspension containing the cement and water, the water representing 20% by weight of the mineral mass of the cement having a viscosity of 35 Pa·s was placed in a crucible. The end of the monolith opposite that which was to be sealed was grasped by a pickup head provided with an inflatable seal to seal the edge of the monolith surrounding said monolith end. The pickup head was connected to a vacuum pump via which an under-pressure was created in the monolith (5×10⁻³ bars). The monolith was lowered into the crucible containing the cement slurry, dosed volumetrically and distributed homogeneously by means of a vibrator. The suction step itself to seal the channels lasted about 5 seconds. The vacuum was then broken to remove the monolith from the pickup head connected to the vacuum pump; the film at the end face, sealed with cement, was removed. This temperature hardened the seals formed at the end of the monolith. The monolith was turned to repeat the sealing operation on the other end face of the monolith. The crucible was again filled with a suspension containing cement with the composition indicated above, and water. The sealed end of the monolith was grasped by a pickup head connected to a vacuum pump via which an under-pressure was created in the monolith (5×10⁻³ bars). After this second suction step, the vacuum was broken, the monolith was freed from the pickup head and the film was withdrawn manually. The seals were finished using a slip stripper. The monolith was then placed on a notched conveyor belt to present its end faces to infrared lamps (70° C.) to dry the seals in a continuous manner for 5 minutes. Drying was followed by a firing step at 1200° C., for 2 hours in a continuous furnace to sinter the seals and the cement. A ceramic filter was obtained with seals at one or other end of the channels having a length of the order of 5 mm. This filter was analyzed by scanning electron microscopy (TEM): the TEM image showed a contact surface between the seals and the porous walls separating the channels of 92%.

### EXAMPLE 2

### Evaluation of Ceramic Filter Based on Honeycomb Monolith Formed from Silicon Carbide Prepared as Described in Example 1 in Filtering Carbonaceous Particles Contained in the Exhaust Gas from a Diesel Engine

A silicon carbide honeycomb monolith was used with square section channels separated from each other by a porous wall 0.4 mm thick the channels of which had been sealed using the method described in Example 1. Said monolith was in the form of a cylinder 6 inch (i.e. 15.24 cm) long by 5.66 inches (i.e. 14.38 cm) in diameter with faces constituted by 200 channels per square inch, i.e. 31 channels per cm². The test monolith was surrounded by in insulating layer (interam) and placed in an envelope (or canning). The envelope was then mounted on the exhaust system downstream of an oxidation catalyst which in turn was placed downstream of a diesel engine.

For the tests, a 2 litre capacity diesel engine was used, provided with a common rail high pressure fuel injection system. The fuel used was a commercial gas oil fuel containing 350 ppm of sulphur and supplemented with 400 ppm of Octel Octimax 4810 additive. The assembly formed by the engine and the exhaust system was integrated into a test bench. The particle filter (PF) was charged with polluting carbonaceous particles present in the diesel engine exhaust system functioning at a level generating a lot of carbonaceous particles. PF regeneration was favoured by the presence of an oxidation catalyst placed upstream of the PF. Said catalyst created a temporary exothermicity by oxidation of post-injected hydrocarbons to reach a temperature sufficient for catalytic oxidation of said particles, thereby regenerating the PF. The test bench and the (automatic charging PF with particles/PF regeneration) swings were controlled using MORPHEE software.

The mass of polluting carbonaceous particles present in the exhaust system from the diesel engine could be accessed by measuring the smoke, easily automated and well correlated to the particle mass. The smoke was measured using an AVL 415S smoke meter placed downstream of the PF and was given by the Bosch index, on a scale from 0 to 10. This measurement consisted of sampling a quantity of exhaust gas downstream of the PF and passing the sample over a filter paper so that a cell could detect the colour (measurement of the level of grey) obtained on the filter paper. This measurement allowed the filtration yield of the PF to be determined.

At each charging/regeneration cycle of the PF, the smoke was measured downstream of the PF. All of the smoke measurements indicated a zero or extremely low emission level: the relative values of the Bosch index measured by the cell were in the range 0 to 0.14 on a scale from 0 to 10, the value 0 corresponding to an absence of colour on the filter paper and the value 10 corresponding to a black colour with escape of an opaque smoke.

Over the total of the charging/regeneration cycles for the PF, all of the values for the Bosch index indicated by the smoke measurement were equal to 0.01, corresponding to an overall filtration efficacy of about 99.8%. The test bench behaviour of the filter over 53 loading cycles followed by regeneration was 10 g/l. Assuming that a load of 7 g/l equals about 800 km distance travelled, this PF thus withstood, without deterioration of the seals, a distance of approximately 61000 km under temperature conditions from 200° C. during the loading phase to 1100° C. during the regeneration phase.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding French application No. 05/13.064, filed Dec. 21, 2005, is incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A process for producing a ceramic honeycomb filter from a porous ceramic honeycomb material comprising a plurality of channels extending through it from one end face to the other end face, said process comprising at least the following steps consisting of:
a) providing each end face of the honeycomb material with a perforated film the perforations of which, produced by irradiation said film at the desired locations with energetic radiation, are such that the channels traversing the material are alternately open at one or the other of their end faces so that, for each channel open at one end face, the adjacent channels are closed; and
b) introducing, by suction through the perforations of the film applied to each end face, a sealing material into the open channels to obtain a ceramic filter the channels of which are not sealed at one of the end faces and are sealed at the other end face.

2. A process according to claim 1, in which step a) is preceded by a step consisting of applying a non-perforated film to each of the end faces of the ceramic material followed by a step consisting of perforating said non-perforated film at the desired locations.

3. A process according to claim 1, in which the film is perforated by irradiating said film at the desired locations using laser type radiation.

4. A process according to claim 3, in which said perforation step is preceded by a step for visual recognition of the end face to be perforated using a digital camera.

5. A process according to claim 1, in which the sealing material is a cement.

6. A process according to claim 1, in which suction is carried out by creating an under-pressure in said material via a vacuum pump.

7. A process according to claim 1, in which said ceramic material is formed from cordierite, mullite, silicon carbide, alpha alumina, silicon nitride, aluminum titanate or zirconium phosphate.

8. A process according to claim 1, in which the seals constituted by sealing material are essentially located on the terminal portion of each of the channels.

9. A process according to claim 1, in which step b) is carried out by initially introducing the sealing material into the channels at the ends of a first end face, drying the seals formed thereby in said channels then introducing the sealing material into the channels at the ends of said second end face.

10. A process according to claim 1, which comprises a step c) consisting of a firing step.

11. A process according to claim 1, which comprises a step for introducing a catalytically active phase into the ceramic filter after carrying out step b).

12. A process according to claim 1, in which said porous ceramic honeycomb material is in the form of fired extrudates.

13. Use of a ceramic filter prepared in accordance with the process claim 1, as a particle filter for diesel engine exhaust systems.

14. Use of a ceramic filter prepared using the process according to claim 1 as a membrane to filter liquid or gaseous effluents.
